(19) United States
(12) Patent Application Publication
(10) Pub. No.: US 2015/0121437 A1
(43) Pub. Date: Apr. 30, 2015

(54) MULTI-PERSPECTIVE GAME BROADCASTING

(71) Applicant: Google Inc., Mountain View, CA (US)

(72) Inventor: Weihua Tan, San Mateo, CA (US)

(73) Assignee: Google Inc., Mountain View, CA (US)

(21) Appl. No.: 13/857,232

(22) Filed: Apr. 5, 2013

(51) Int. Cl. H04N 21/262

(52) U.S. Cl. CPC H04N 21/262
USPC 725/93

(57) ABSTRACT

Methods, systems, and computer program products for providing multi-perspective broadcasting of multiplayer computer games are described. A computer-implemented method may include receiving a request to broadcast a match of an online multi-player game, generating the requested broadcast using available video streams from at least two participants in the match, and transmitting the generated broadcast to a display interface to allow a viewer to observe the match from one or more of the available video streams.

### TECHNICAL FIELD

The field generally relates to computer systems and, more particularly, to displaying computer generated content.

### BACKGROUND

A video game is an electronic or computerized game that is played by manipulating images presented on a display. A multiplayer video game allows numerous participants to play in a single game environment. Online multiplayer video games allow participants in different locations to play over a computer network.

Streaming media generally describes multimedia content delivered as a continuous stream of data. For example, a video streamed over the Internet by a content provider may be displayed by a client media player in real-time. Streaming media may be generated from prerecorded files or may be delivered as a live broadcast.

Today, websites such as video sharing and social networking sites typically allow users to broadcast their own video content. For example, a video game participant may stream their participation in an online video game match to others around the world.

However, different video streams broadcast by different players from the same exact match usually are not related. Therefore, a viewer watching a participant video stream is limited to a single perspective and is not likely to know about other available broadcasts from the same match. In addition, a viewer cannot interact and share their experience with other viewers watching the same match from a different participant video stream.

### SUMMARY

Methods, systems, and computer program products for providing multi-perspective broadcasting of computer games are described. In one embodiment, a processor receives a request to broadcast a match of an online multi-player game, generates the requested broadcast using available video streams from at least two participants in the match, and transmits the generated broadcast to a display interface to allow a viewer to observe the match from one or more of the available video streams.

In another embodiment, a system including a memory and a processing device coupled with the memory is configured to receive a request to broadcast a match of an online multi-player game, generate the requested broadcast using available video streams from at least two participants in the match, and transmit the generated broadcast to a display interface to allow a viewer to observe the match from one or more of the available video streams.

In a further embodiment, a computer-readable medium has instructions stored thereon that when executed by a processor, cause the processor to perform operations. The instructions include computer-readable program code configured to cause the processor receive a request to broadcast a match of an online multi-player game, generate the requested broadcast using available video streams from at least two participants in the match, and transmit the generated broadcast to a display interface to allow a viewer to observe the match from one or more of the available video streams.

Further embodiments, features, and advantages of the disclosure, as well as the structure and operation of the various embodiments of the disclosure are described in detail below with reference to accompanying drawings.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements. The drawing in which an element first appears is generally indicated by the left-most digit in the corresponding reference number.

FIG. 1 illustrates an exemplary system architecture, in accordance with various embodiments of the present disclosure.

FIG. 2 is a flow diagram illustrating multi-perspective game broadcasting, according to an embodiment.

FIG. 3 is a flow diagram illustrating additional aspects of multi-perspective game broadcasting, according to an embodiment.

FIG. 4 illustrates an example user interface for providing a multi-perspective video game broadcast and interaction among viewers of the same match, according to an embodiment.

FIG. 5 is a block diagram of an exemplary computer system that may perform one or more of the operations described herein.

### DETAILED DESCRIPTION

An increasing number of users broadcast their own live video content on the Internet each day. Many websites, such as video sharing and social networking sites, allow users to stream video content for others to enjoy. For example, a user may stream their participation in an online video game to share the experience with others. Viewers may watch the match using a video player without participating in the game, and even without having access to a game console or game engine.

However, the user experience for a viewer watching a single video stream is usually limited. For example, a viewer only can see the individual perspective of the participant providing the live broadcast, even when other participants are streaming broadcasts of the same match of the online video game. In addition, viewers of one live broadcast typically cannot easily interact with and may not be aware of other viewers watching different live broadcasts of the same match or event. Thus, viewers are generally unable to enjoy a variety of available perspectives, and also miss out on interacting with other viewers who have a common interest.

Methods, systems, and computer program products for providing multi-perspective broadcasting of a computer game are described. Embodiments of the present disclosure allow viewers of an online multiplayer video game match to access multiple available video streams provided by different match participants using a single display interface. Further, since the video streams for a match are combined into a single interface, viewers watching any of the available video streams for a match or event are brought together as a collective audience.

In one example, multiple participants of a multiplayer video game match request to have their individual play broadcast as a live video stream. A video game engine of an online game server or game console calls a broadcast provider API to create a broadcast for the match.

The broadcast provider then generates a live broadcast for the match. The game engine then sends participant video streams and game data to the broadcast provider as the match is played. The broadcast provider converts the video stream data received from the video game server into displayable video data. The video streams from different match participants are associated and grouped together based on a unique match identifier. The video streams identified for the match are then presented to one or more viewers as selectable views on a multi-perspective (e.g., multi-camera) video player display based on the associations.

The multi-perspective video player presents each individual participant video stream as a selectable camera view that can be selected for display. A viewer may easily switch between watching available video streams of the same match by choosing an available video stream broadcast presented by the multi-perspective video player. The multi-perspective video player may be provided on a display interface that allows all of the viewers watching the same event, even from different perspectives, viewpoints or video streams, to interact and share feedback with each other about the event in real-time as the event occurs.

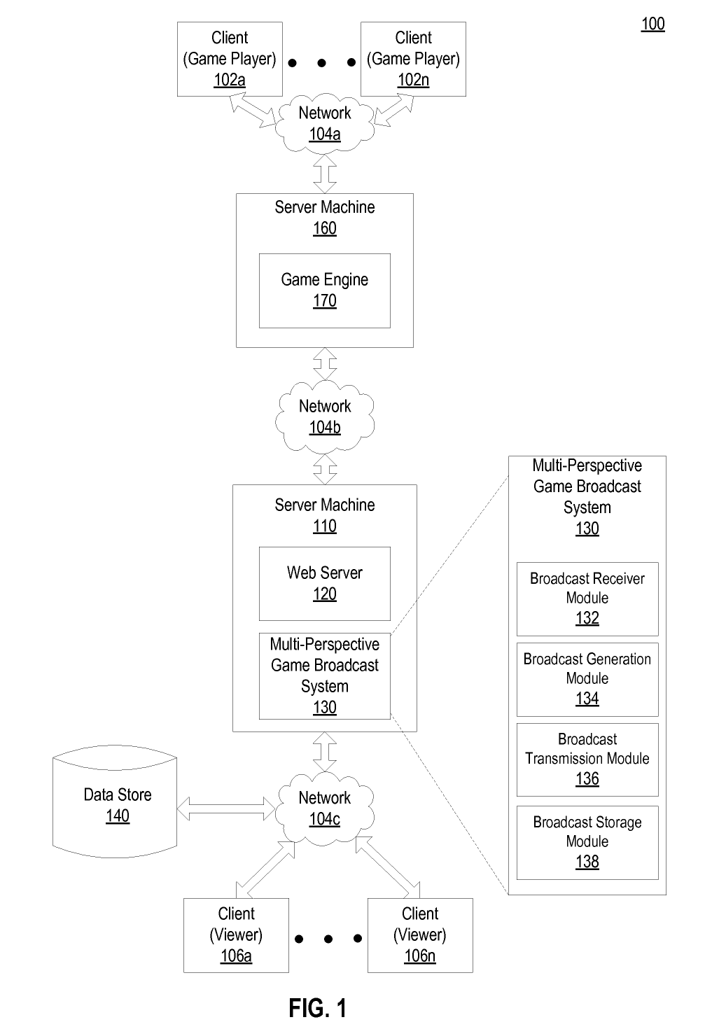

FIG. 1 illustrates exemplary system architecture 100 in which embodiments can be implemented. The system architecture 100 includes client machines 102A-102N and a server machine 160 connected to a network 104A. Server machine 110 and server machine 160 are connected to a network 104B. Server machine 110, a data store 140 and client machines 106A-106N are connected to a network 104C. Networks 104A-104C may be one or more of a public network (e.g., the Internet), a private network (e.g., a local area network (LAN) a wide area network (WAN)), or a combination thereof.

The client machines 102A-102N may be personal computers (PC), laptops, mobile phones, tablet computers, standard game consoles, portable game consoles, handheld game consoles, or any other computing device. The client machines 102A-102N may run an operating system (OS) that manages hardware and software of the client machines 102A-102N. Video game software may run on the client machines (e.g., on the OS of the client machines). The video game software may allow a user to play video games locally, online, and/or in conjunction with, or with the assistance of one or more other computing devices, such as server machine 160.

Server machine 160 may be a rackmount server, a router computer, a personal computer, a portable digital assistant, a mobile phone, a laptop computer, a tablet computer, a camera, a video camera, a netbook, a desktop computer, a media center, a standard game console, a portable game console, a handheld game console, or any other computing device. Server machine 160 may include a video game engine 170 that allows client machines 102A-102N to participate in the same video game match over a computer network.

Video game engine 170 provides a video game environment to one or more players of a video game match. In one embodiment, video game engine may provide an online game environment to allow multiple participants in different locations to play a video game match over a computer network. For example, video game engine may receive inputs from game participants, manage match progression based on inputs received from game participants, and may generate and provide a display of a game environment during a match to each of the participants. In some embodiments, video game engine 170 may run on one or more different machines, such as a game console, a game server, or one or more other computing devices.

Server machine 110 may be a rackmount server, a router computer, a personal computer, a portable digital assistant, a mobile phone, a laptop computer, a tablet computer, a camera, a video camera, a netbook, a desktop computer, a media center, any type of game console, or any type of computing device. Server machine 110 may include a web server 120 and a multi-perspective game broadcast system 130. In some embodiments, the web server 120 and multi-perspective game broadcast system 130 may run on one or more different machines.

Web server 120 may provide data and/or video content from data store 140 to clients 106A-106N or other applications and systems that provide data and or video content to client 106A-106N. Clients 106A-106N may locate, access and view stored or live streaming video content from web server 120 using a web browser, application, and/or video player. Stored video content may reside in data store 140. Live streaming video content may be generated and/or received from one or more sources by server machine 110.

Web server 120 may receive queries for stored and/or live streaming video content and may perform searches for stored and/or live streaming video content using data store 140 to locate video data satisfying the search queries. Web server 120 then may send a client 106A-106N results matching the search query. Such functionality also may be provided, for example, as one or more different web applications, standalone applications, mobile applications, systems, plugins, web browser extensions, and application programming interfaces (APIs).

Data store 140 is persistent storage that is capable of storing various types of data, including video content. In some embodiments data store 140 might be a network-attached file server, while in other embodiments data store 140 might be some other type of persistent storage such as an object-oriented database, a relational database, and so forth. Data store 140 may include user generated content (e.g., user generated videos) uploaded by client machines 102A-102N. The data may additionally or alternatively include content provided by one or more other parties. Video content may be added to the data store 140 as discrete files (e.g., motion picture experts group (MPEG) files, windows media video (WMV) files, joint photographic experts group (JPEG) files, graphics interchange format (GIF) files, portable network graphics (PNG) files, etc.), or as components of a single compressed file (e.g., a zip file).

The client machines 106A-106N may be personal computers (PC), laptops, mobile phones, tablet computers, traditional game consoles, portable game consoles, handheld game consoles, or any other computing device. The client machines 102A-102N may run an operating system (OS) that manages hardware and software of the client machines 102A-102N. A browser (not shown) may run on the client machines (e.g., on the OS of the client machines). The browser may be a web browser that can access content served by a web server. The browser may display video content and other visual media provided by a server (e.g., a web or content server).

Server machine 110 also includes a multi-perspective game broadcast system 130. The multi-perspective game broadcast system 130 includes a broadcast receiver module 132, a broadcast generation module 134, a broadcast transmission module 136, and a broadcast storage module 138. In other embodiments, functionality associated with one or more of broadcast receiver module 132, a broadcast generation module 134, a broadcast transmission module 136, and a broadcast storage module 138 may be combined, divided and organized in various arrangements.

In an embodiment, multi-perspective game broadcast system 130 is coupled to data store 140, which may store video data. Video data generally refers to any type of moving image, which includes, but is not limited to movie films, videos, digital videos and other forms of animated drawings or display. For example, video data may include digital videos having a sequence of static image frames that also may be stored as image data. Thus, each image frame may represent a snapshot of a scene that has been captured according to a time interval. Video data may include computer animations, including two-dimensional and three-dimensional graphics. Video data also may include any sequence of images, including graphical drawings that create an illusion of movement.

Broadcast receiver module 132 receives requests to generate a broadcast of one or more available video streams for an event. A broadcast generally describes the offering and/or distribution of audio, video, or any other type of multimedia content to an audience using any type of communication medium.

In an embodiment, broadcasting may comprise transmitting multimedia content received from one or more different sources to one or more different destinations. Multimedia content received from a source may be transmitted to one or more destinations using one or more distribution methods, which may include but are not limited to, unicast, broadcast, multicast, anycast, and geocast distribution.

In addition, one or more different types of distribution protocols may be used to perform content distribution. For example, multicast distribution may be performed using one or more multicast-specific distribution protocols, such as, Internet Group Management Protocol (IGMP), Protocol Independent Multicast (PIM), Distance Vector Multicast Routing Protocol (DVMRP), Multicast Open Shortest Path First (MOSPF), Multicast BGP (MBGP), Multicast Source Discovery Protocol (MSDP), Multicast Listener Discovery (MLD), GARP Multicast Registration Protocol (GMRP), and Multicast DNS (mDNS).

A generated broadcast also may include a location or area where available content may be publicized and/or offered for distribution. In one example, a broadcast may have an associated webpage that provides viewers with descriptive information about a broadcast and access to one or more different sources of content associated with the broadcast. For example, a broadcast-specific webpage may serve as a centralized location where viewers may access (e.g., browse, launch, display, etc.) various forms of content, such as audio and video streams, that are available for an event.

In an embodiment, broadcast receiver module 132 receives a request to stream one or more live video broadcasts of an event. In an embodiment, broadcast receiver module 132 receives a request to stream one or more stored or archived video broadcasts. In one example, broadcast receiver module 132 may receive a request to broadcast the match of an online multiplayer video game. In an example, broadcast receiver module 132 may receive requests, for example, from a game engine on a game server, game console, or any other computing device.

Broadcast generation module 134 generates a requested broadcast using available video streams from at least two participants. For example, broadcast generation module 134 may receive a match identifier that uniquely identifies an event, such as a match of an online game played by multiple participants. Broadcast generation module 134 then may create the requested broadcast for the uniquely identified match.

In one example, the requested broadcast is created by adding a new instance of a broadcast in a database or application and associating the match identifier with the newly added broadcast. The generated broadcast then may be associated with one or more multimedia content streams received from one or more content sources. Multimedia content streams may be received individually or may be received in a bundle from each of one or more content sources. Similarly, a broadcast provider may distribute available multimedia streams for a broadcast to each viewer as individual content streams and/or as a bundle of content streams that may be displayed individually or together.

Broadcast generation module 134 may identify one or more associated video streams from different participants of a match based on the match identifier. For example, the match identifier may be included as metadata describing a participant video stream. Broadcast generation module 134 detects the match identifier provided with a video stream (e.g., within metadata, in the video stream itself, etc.) and then associates the video stream with a broadcast based on the match identifier. In one example, broadcast generation module 134 creates a new video stream instance (e.g., within a database or an application) and associates the newly created video stream with a broadcast instance having a corresponding match identifier.

In an embodiment, a broadcast provider receives one or more multimedia content streams from one or more different sources. In an example, a broadcast provider may receive dozens of video streams that are each associated with different participants in the same online multiplayer video game match. Some of the video streams may be received from individual participants (e.g., personal game consoles or computing devices) while other video streams may be received from an online game server. The broadcast provider may replicate one or more of the video streams it receives to provide on-demand distribution.

For example, a broadcast provider may replicate video streams on one or more computing devices (internally and/or externally, including on network devices such as routers and switches) to facilitate distribution to viewers in various locations. In one example, a broadcast provider distributes a single copy of a video stream to multiple viewers. In another example, a broadcast provider creates and distributes duplicate copies of the same video stream to each of one or more viewers.

In an embodiment, broadcast generation module 134 creates content to make the created broadcast available to viewers. For example, broadcast generation module 134 may generate or update one or more websites to include a newly created broadcast. Broadcast generation module 134 also may generate and send messages (e.g., e-mail, SMS, instant message, etc.) to promote a broadcast. Broadcast generation module 134 also may modify one or more searchable data stores (including search engine metadata) to allow users to browse and search for broadcast events.

Broadcast transmission module 136 transmits the generated broadcast to a display interface of a viewer. In an embodiment, a generated broadcast is a broad collection of information and resources that a broadcast provider is able to provide for an event. For example, a generated broadcast may include a collection of data and/or metadata describing an event and one or more sources of multimedia content (e.g., streaming content) for an event that a broadcast provider is able to deliver upon request.

In one example, a generated broadcast may be provided to a viewer as part of a webpage or application that includes at least one video player. The display interface providing the generated broadcast may present information describing the event, its participants, and its viewers. The display interface also may allow a viewer to launch one or more available video streams associated with the generated broadcast for display within a single user interface.

In an example, available video streams for an event received by a broadcast server are redistributed to viewers for display (e.g., using distribution methods such as unicast, broadcast, multicast, anycast, geocast, etc.). According to an embodiment, the display interface presents each of the available video streams as selectable camera views that are displayable in a viewing area of a video player when selected by a viewer.

Broadcast storage module 138 stores a generated broadcast for subsequent retrieval and display. In one embodiment, a broadcast is stored to allow one or more viewers to watch a previously presented portion of an ongoing broadcast or to watch any part of a completed broadcast.

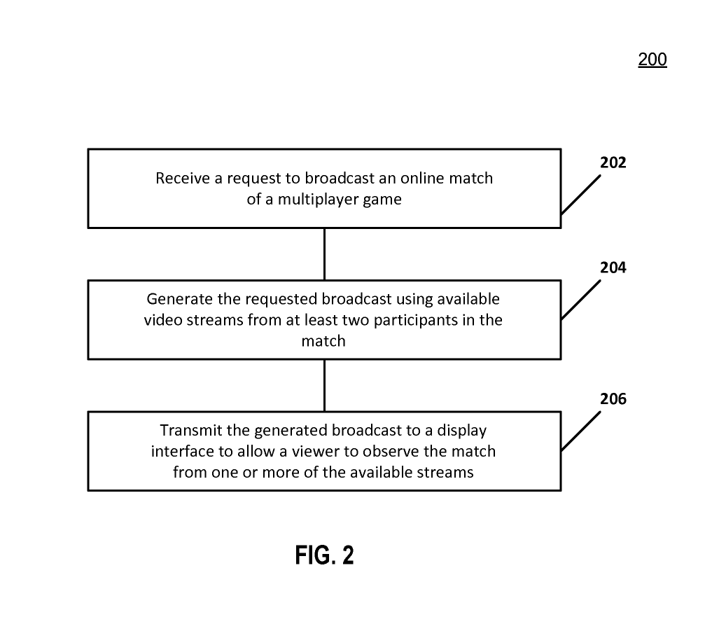

FIG. 2 is a flow diagram illustrating multi-perspective game broadcasting, according to an embodiment. The method 200 is performed by processing logic that may comprise hardware (circuitry, dedicated logic, etc.), software (such as is run on a general-purpose computer system or a dedicated machine), or a combination of both. In one embodiment, the method 200 is performed by the server machine 110 of FIG. 1. The method 200 may be performed by multi-perspective game broadcast system 130 running on server machine 110 or one or more other computing devices.

Method 200 begins at stage 202, when a request is received to broadcast an online match of a multiplayer video game. In one example, one or more participants (i.e., players) of a multiplayer video game may initiate a request to broadcast video of their own individual play in a match. For example, a participant may initiate the request from a game console, online game server, or any other computing device. Further, the request may be received prior to the start of the match or when the match is played between participants.

In one example, a participant may manually initiate a video stream broadcast for the match. In another example, a participant may set a user preference to automatically initiate a video stream broadcast for the match. In yet another example, a match may be configured to automatically request broadcasting of a video stream for each participant in the match based on one or more of a default, match setting, or system setting.

According to an embodiment, a game engine residing on a game server, game console, or other computing device sends a request to broadcast a match of a multiplayer game by making a system or API call to a video broadcast/streaming provider. For example, code within a game engine may be configured to call a broadcast provider API to create a broadcast for an online multiplayer game. In one example, a game participant having limited bandwidth may request that a game server generate and send live streaming data to the broadcast provider (e.g., rather than from a local game console having limited network bandwidth). Broadcast data sent from a game engine may be received by a broadcast provider and converted into displayable video data. Stage 202 may be performed by, for example, broadcast receiver module 132.

At stage 204, the requested broadcast is generated using an available video stream from at least two participants in the match. In one embodiment, a game engine on a game server or game console provides metadata about a match to a broadcast provider. For example, a game engine may provide metadata such as the match ID, match title, game title, a start time, an end time, and/or a video format or resolution to an online broadcast provider.

In an example, a game engine sends a match identifier that uniquely identifies a match to a broadcast provider. For example, a match ID sent as metadata may uniquely identify the match. In another example, another field or combination of fields that uniquely identify a match may be provided.

In one example, a broadcast provider also may generate a match identifier based on receiving a request to broadcast a match. The broadcast provider then may communicate the generated match identifier to a game engine requesting the match. The game engine then may communicate the generated match identifier to one or more game consoles, game servers, or other computing devices associated with the match. The game consoles, game servers, or other computing device(s) then may supply the generated match identifier to the broadcast provider when communicating match data (e.g., game data, video streams) to allow the broadcast provider to associate the incoming data with a broadcast generated for the match.

In an embodiment, one or more video streams of a match are associated with a generated broadcast based on a match identifier. For example, a unique match identifier may be assigned to or associated with a broadcast. A video stream also may include the same match identifier, for example, in a header or another part of video stream data. A broadcast provider may analyze video stream data or metadata describing a video stream to detect a match identifier. In one example, the broadcast provider associates one or more video streams with a broadcast based on a common, unique match identifier. The broadcast provider then may present the video streams associated with the broadcast to a viewer in a user interface. Stage 204 may be performed by, for example, broadcast generation module 134.

At stage 206, the generated broadcast is transmitted to a display interface to allow a viewer to observe the match from one or more of the available video streams. In one embodiment, metadata describing a generated broadcast, including information about multiple available video streams associated with the generated broadcast, is transmitted to a display interface of a viewer. In one example, the information may be used to initialize and/or format the display interface of the viewer. For example, information about the generated broadcast may be used to provide headings, description, and/or available video stream selections for a match within a display interface.

A display interface may be part of a web application, a standalone application, a mobile application, and/or a video player. In one embodiment, the display interface includes a multi-camera video player that presents each of the available video streams for the match as selectable camera views that are displayable in a viewing area of the video player when selected by a viewer. For example, information about a group of associated/related video streams may be sent to a multi-camera video player of a viewer using an API. A multi-camera video player may use the information about the associated/related video streams to generate a selectable set of “camera” views in a single interface presented to a viewer. A viewer then may initiate display of an available video stream by selecting an available camera view. A viewer also may easily switch between available video streams for the same match by selecting a different available camera view from the same user interface.

In an example, a single video stream is delivered for display to a viewer based on a selection received from the viewer. Multiple available video streams also may be delivered, for example, individually or in a bundle, regardless of whether one or more of the available video streams are displayed to the viewer. Video stream data also may be delivered, for example, in a compressed and/or encrypted format, and may be decompressed, decrypted, and/or converted between formats to allow display.

In one embodiment, a video stream for a participant of a multiplayer video game match represents an individual player's camera view or perspective of the game environment. For example, the video stream for a participant may be based on a first-person perspective of a participant's avatar in the video game match. Other possible perspectives include, but are not limited to, a top-down perspective, a third person perspective, a fixed/static perspective, and/or a dynamically calculated perspective.

In an embodiment, one or more available video streams are generated for non-human participants in a video game match. For example, a video stream may be generated for a game player controlled by a computer or game engine. In an example, a video stream may be associated with a moveable or immoveable object within the video game environment. In another example, a video stream may be associated with a fixed location or dynamic set of locations within the video game environment. Stage 206 may be performed by, for example, broadcast transmission module 136.

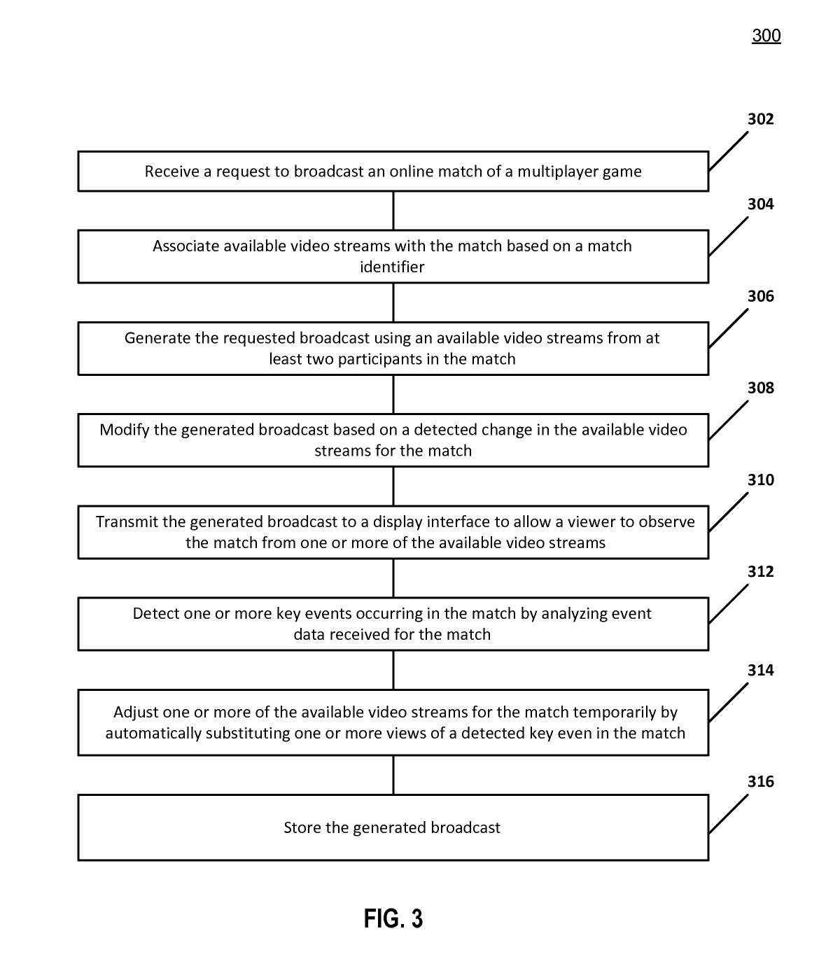

FIG. 3 is a flow diagram illustrating additional aspects of multi-perspective game broadcasting, according to an embodiment. The method 300 is performed by processing logic that may comprise hardware (circuitry, dedicated logic, etc.), software (such as is run on a general purpose computer system or a dedicated machine), or a combination of both. In one embodiment, the method 300 is performed by the server machine 110 of FIG. 1. The method 300 may be performed by multi-perspective game broadcast system 130 running on server machine 110 or one or more other computing devices.

Method 300 begins at stage 302, when a request is received to broadcast a match of an online multiplayer video game. In an embodiment, broadcast receiver module 302 receives a request sent from an online game server or game console to broadcast one or more live video streams from an online match between multiple participants playing a video game. In one example, the request may be initiated by a user from a game console or other computing device. Stage 302 may be performed by, for example, broadcast receiver module 132.

At stage 304, one or more available video streams are associated with the match based on a match identifier. In one embodiment, video streams received may be associated with a match and/or other video streams based on a unique identifier. In one example, a match identifier is a unique id for a match. Video stream data or metadata may include a match identifier indicating the video stream is associated with a particular match. In another example, a group of related matches may be assigned a unique identifier to relate the group of matches. For example, a group matches for a tournament or competition may be related or further related based on an additional unique match grouping identifier. Stage 304 may be performed by, for example, broadcast generator module 134.

At stage 306, the requested broadcast is generated using an available video stream from each of at least two participants in the match. In an embodiment, a requested broadcast is generated for a match using one or more computing devices. A broadcast provider may manage any number of distinct generated broadcasts (e.g., one, dozens, hundreds, thousands, etc.). Each generated broadcast may be managed as a session that includes its own data and associated video streams.

A generated broadcast may include one or more video streams provided by video game match participants. In one example, a single match participant may generate one or more available video streams. For example, a match participant may broadcast their own match play as a single video stream. In addition, a match participant also may broadcast video captured from a personal recording device, such as a video camera connected to a game console or other computing device.

In one embodiment, multiple video streams provided by a single participant may be displayed as separate video streams or may be displayed simultaneously. (e.g., picture-in-picture) In one example, a broadcast of a participant's game play is combined with video captured from the participant's personal recording device. For example, a video stream may include a picture-in-picture or side-by-side display of a participant's gameplay with video captured from their personal recording device. In one example, sound generated from either the game environment or the participant's personal environment may be provided. In an example, sounds from the game environment and a participant's personal environment are integrated/played together at the same time, for example, at equivalent or different volumes.

In an embodiment, a viewer enters a search for a match and receives a list of available broadcast matches that are available for viewing. The user selects one of the available broadcast matches for display. The user selection may launch a display interface that provides a listing of selectable video streams associated with the selected broadcast match. In an example, the video streams associated with the selected broadcast match are determined based a unique match identifier. Stage 306 may be performed by, for example, broadcast generator module 134.

At stage 308, the generated broadcast is modified based on a detected change in the available video streams for a match. According to an embodiment, one or more video streams may be initiated or terminated during a broadcast. For example, new participants may enter a match and existing participants may decide to leave or discontinue broadcasting video of their gameplay.

In one example, a change in available video streams for a match may be detected based on an event associated with creation or termination of a video stream. A change in available video streams for a broadcast also may be detected, for example, by comparing and/or analyzing data used to track available video streams for a broadcast (e.g., based on a match identifier or other unique identifier for an event).

In an embodiment, a generated broadcast is updated to include previously unavailable video streams that are newly detected. In one example, a new video stream becomes available for a broadcast of a match. For example, a new or existing participant in a match may initiate broadcasting of their gameplay as a video stream.

In one embodiment, video streams that are detected to be inactive/unavailable are removed from the generated broadcast. For example, a participant may decide to stop broadcasting their gameplay as a video stream, may leave the match, or may lose connectivity. In an example, the generated broadcast may be updated periodically based on a time interval or immediately as changes are detected.

In one example, viewers having a display interface directed to the generated broadcast are alerted through the display interface that the generated broadcast has been updated. In another example, viewer display interfaces are automatically refreshed when a generated broadcast has been updated. For example, selectable thumbnail images of available video streams may be added or removed automatically from a display interface of a viewer based on the detection of new or removed video streams for a generated broadcast. Stage 308 may be performed by, for example broadcast generator module 134.

At stage 310, the generated broadcast is transmitted to a display interface to allow a viewer to observe a match from one or more of the available video streams. In an embodiment, a generated broadcast is transmitted to one or more viewers each having their own display interface.

In one example, a viewer may search for a match by name, match id, a player name, game name, match type, match length, and/or one or more additional or other criteria. When a viewer finds a match of interest, for example, through search or navigation, the user may be presented with a display interface that provides additional information about the match, including one or more different available viewpoints/camera perspectives that may be selected for display. When a user selects an available viewpoint/camera perspective of the broadcast, video data streamed (either directly or indirectly) from a game server, game console, or other computing device is played in a video player window. The user then may switch to another available viewpoint/camera perspective by selecting another available video stream. Stage 310 may be performed by, for example, broadcast transmitter module 136.

At stage 312, one or more key events occurring in the match are detected by analyzing event data received for the match. A key event generally describes a scenario or interaction occurring within a match, which a game engine has indicated or flagged within game data to be important to one or more match participants and/or viewers. For example, a key event in a sports game may be an interaction, activity, or result (e.g., block, move, great play, goal, injury, etc.) that is likely to be of interest to participants and viewers. In another example, a key event in an action game may be an event that influences or results in the outcome of the match (e.g., a momentum-changing event, a full/partial defeat of an opponent, team member activity, etc.). Key events may be indicated or flagged within game data based on one or more predefined codes, descriptions, and/or other identifiers.

In an embodiment, a game engine sends game data describing events and interaction that are occurring or have occurred in a match to a broadcast provider as the match is played by participants. In one example, the game data is sent to a broadcast provider as a continuous stream of data. The game data may be packaged with one or more available video streams or may be provided individually (with associated video streams being provided separately). The data sent from the game engine may be analyzed, and one or more key events occurring in the match may be detected based on the analysis. A game engine may specifically identify/designate one or more key events for a match in data it generates for the match. For example, key events may be indicated by specifically assigned codes, descriptions, and/or values. Stage 312 may be performed by, for example, broadcast generator module 134.

At stage 314, one or more of the available video streams for the match are temporarily adjusted by automatically transitioning the video streams to display one or more views associated with a detected key event in the match (e.g., a goal, a touchdown, an amazing move, defeat of another player, etc.), as indicated by game data provided by a game engine. In an embodiment, a game engine may send one or more corresponding animations and/or video clips to be inserted into or to temporarily replace a video stream to provide one or more informative views of an event (e.g., a close-up view of a key event, or views of a key event from one or more different participant perspectives). In one embodiment, a game engine may indicate one or more alternative video streams to display on a temporary basis.

In an example, multiple animations, video clips, and/or alternative perspectives may be received for one or more detected key events and may be presented to a viewer based on one or more of timing, sequence, and/or user preference. Multiple animations, video clips, and/or camera views also may be inserted into a broadcast simultaneously (e.g., picture-in-picture, split screen, etc.). According to an embodiment, stage 314 may be performed by, for example, broadcast generator module 136.

At stage 316, the generated broadcast of the match is stored. In one embodiment, a broadcast is stored for preservation purposes, such as to provide a previously occurring video segment to one or more viewers. For example, a broadcast may be stored to allow one or more viewers to access and observe the broadcast after an online multiplayer video game match has ended. Stage 316 may be performed by, for example, broadcast storage module 138.

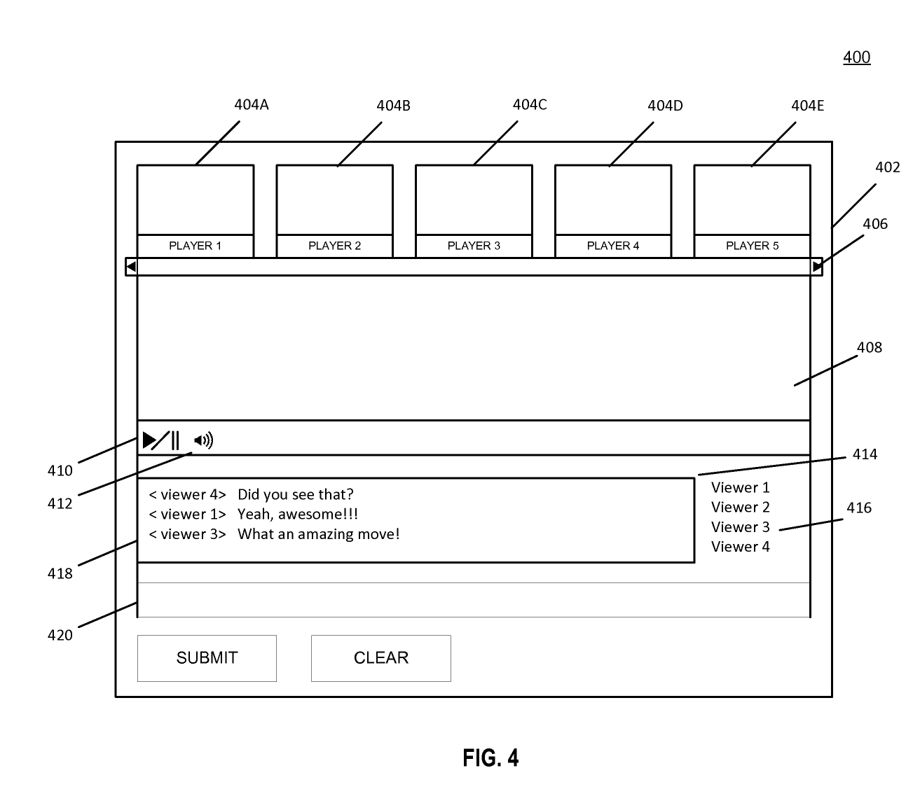

FIG. 4 illustrates an example user interface for providing a multi-perspective video game broadcast and interaction among viewers of the same match, according to an embodiment. Example user interface 400 includes display interface 402, available video streams 404A-404E, scroll bar 406, video player 408, a play/pause control 410, an audio control 412, a communication interface 414, a list of match viewers 416, match viewer comments 418, and comment entry field 420.

Display interface 402 allows a viewer of an online video game match broadcast to browse available video streams 404A-404E for the match. In one embodiment, available video streams 404A-404E may be provided as thumbnail images and may also include information about an available video stream, such as a participant screen name. In one example, one or more available video streams 404A-404E each may be presented as a static image snapshot from a corresponding video stream or other static images, such as a player profile picture or player avatar. In another example, one or more available video streams 404A-404E may be presented as streaming thumbnail broadcasts, each corresponding to an available video stream. In an example, a viewer may use a scrollbar 406 or other user interface control to navigate between and/or access available video stream indicators that are not immediately displayed.

In an embodiment, a viewer of a match may select one or more of available video streams 404A-404E for display. For example, the viewer may select a thumbnail image representing an available video stream 404A to display the corresponding available video stream in video player 408. In another example, a user may select multiple thumbnail images representing available video streams (e.g., 404A-404B), which each may be displayed by video player 408. For example, multiple video streams may be displayed simultaneously by video player 408 in a split screen, quadrants or other multi-view configuration. In an embodiment, video player 408 may include a play/pause control 410, an audio control 412, and one or more other controls to allow a viewer to adjust presentation of an available video stream.

According to an embodiment, display interface 402 includes a communication interface 414 to allow viewers watching video streams of the same match to interact and share their experiences. For example, communication interface 414 may include a list of match viewers 416 who may submit comments 418 using comment entry field 420. In other embodiments, viewers may interact using audio and/or video chat features.

In an embodiment, viewers may vote on one or more aspects of a match. In some examples, viewers may be presented with one or more opportunities to vote on various aspects of a match before, during, or after a match. In one example, viewers may select the most valuable player of a match (e.g., at the end of the match, at different segments of the match, etc.). Viewers may also vote on other aspects of the match, such as best team, best events, etc. In another example, aspects of the match may be determined by analyzing data associated with a generated broadcast. For example, a match participant attracting the most viewers or most total viewing time among different viewers may be determined. Further, match participants may be awarded based on aspects of a match determined by viewer voting and/or analysis of data associated with a generated broadcast.

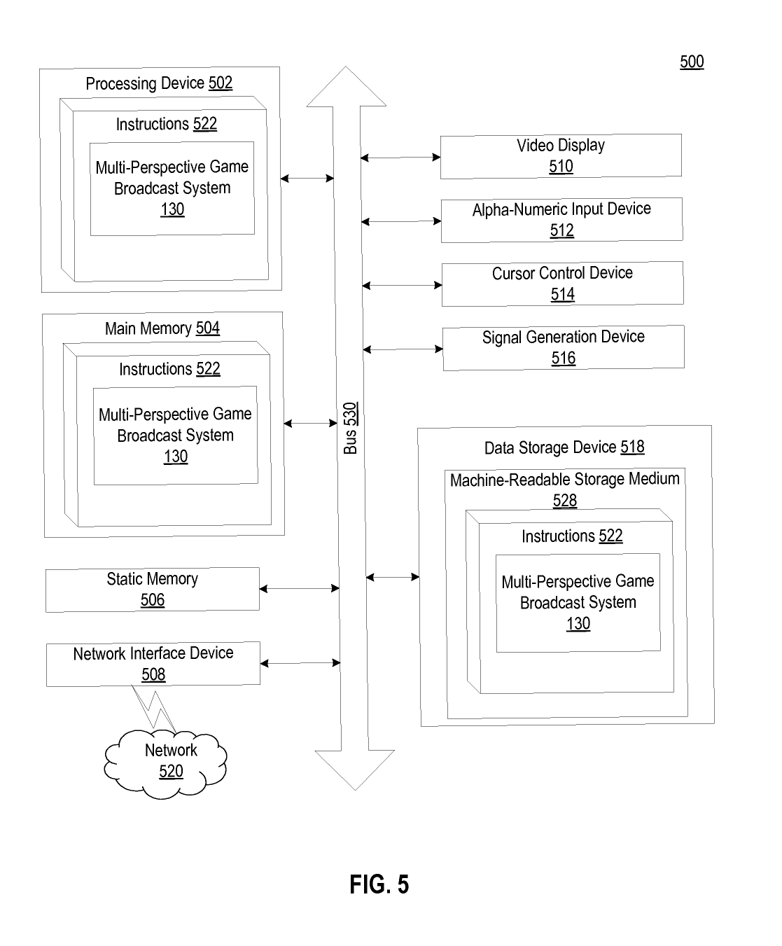

FIG. 5 illustrates a diagram of a machine in the exemplary form of a computer system 500 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device (processor) 502, a main memory 504 (e.g., read-only memory (ROM), flash memory, dynamic random access memory (DRAM) such as synchronous DRAM (SDRAM), double data rate (DDR SDRAM), or DRAM (RDRAM), etc.), a static memory 506 (e.g., flash memory, static random access memory (SRAM), etc.), and a data storage device 518, which communicate with each other via a bus 530.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 may also be one or more special-purpose processing devices such as an application specific integrated circuit (ASIC), a field programmable gate array (FPGA), a digital signal processor (DSP), network processor, or the like. The processor 502 is configured to execute instructions 522 for performing the operations and steps discussed herein.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a computer-readable storage medium 528 on which is stored one or more sets of instructions 522 (e.g., software) embodying any one or more of the methodologies or functions described herein. The instructions 522 may also reside, completely or at least partially, within the main memory 504 and/or within the processor 502 during execution thereof by the computer system 500, the main memory 504 and the processor 502 also constituting computer-readable storage media. The instructions 522 may further be transmitted or received over a network 520 via the network interface device 508.

In one embodiment, the instructions 522 include instructions for a video trailer generation system (e.g., multi-perspective game broadcast system 130 of FIG. 1) and/or a software library containing methods that call a multi-perspective game broadcast system. While the computer-readable storage medium 528 (machine-readable storage medium) is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “computing”, “comparing”, “applying”, “creating”, “ranking,” “classifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Certain embodiments of the present disclosure also relate to an apparatus for performing the operations herein. This apparatus may be constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. (Currently provided) A computer-implemented method, comprising:
receiving a request to broadcast a match of an online multi-player game;
generating, using a processor, the requested broadcast using available video streams for the match from at least two participants in the match; and
transmitting, using the processor, the generated broadcast to a display interface to allow a viewer to observe the match from one or more of the available video streams.

2. The method of claim 1, wherein generating the requested broadcast comprises:
associating one or more of the available video streams with the match based on a match identifier.

3. The method of claim 1, wherein the display interface comprises:
a video player that presents each of the available video streams for the match as selectable camera views that are displayable in a viewing area of the video player when selected by the viewer observing the match.

4. The method of claim 1, further comprising:
modifying the generated broadcast based on a detected change in the available video streams for the match.

5. The method of claim 1, further comprising:
receiving a match identifier that uniquely identifies the match;
receiving a first video stream with the match identifier for a first participant in the match; and
receiving a second video stream with the match identifier for a second participant in the match.

6. The method of claim 1, wherein each of the available video streams provides a view of the match from a perspective of a respective participant in the match.

7. The method of claim 1, wherein at least one of the available video streams is associated with a non-human participant in the match.

8. The method of claim 1, further comprising:
detecting one or more key events occurring in the match by analyzing event data received for the match; and
adjusting one or more of the available video streams for the match temporarily by automatically substituting one or more views of a detected key event in the match.

9. The method of claim 1, wherein at least one of the available video streams includes a video stream from a video camera of a participant in the match.

10. The method of claim 1, wherein the transmitting comprises streaming one or more of the available video streams to the display interface of the viewer based on a selection.

11. The method of claim 1, further comprising:
storing the generated broadcast of the match; and
providing the stored broadcast to one or more viewers after the match has ended.

12. The method of claim 1, wherein the viewer is someone other than a participant in the match.

13. The method of claim 1, wherein the display interface allows communication between viewers of the match.

14. The method of claim 1, wherein the display interface allows viewers of the match to vote on one or more aspects of the match.

15. A system comprising:
a memory; and
a processor coupled with the memory to:
receive a request to broadcast a match of an online multi-player game;
generate the requested broadcast using available video streams for the match from at least two participants in the match; and
transmit the generated broadcast to a display interface to allow a viewer to observe the match from one or more of the available video streams.

16. The system of claim 15, wherein the display interface comprises:
a video player that presents each of the available video streams for the match as selectable camera views that are displayable in a viewing area of the video player when selected by the viewer.

17. The system of claim 15, wherein the processor further:
detects one or more key events occurring in the match by analyzing event data received for the match; and
adjusts one or more of the available video streams for the match temporarily by automatically substituting one or more views of a detected key event in the match.

18. A computer readable medium having instructions stored thereon that, when executed by a processor, cause the processor to perform operations comprising:
receiving a request to broadcast a match of an online multi-player game;
generating, using the processor, the requested broadcast using available video streams for the match from at least two participants in the match; and
transmitting, using the processor, the generated broadcast to a display interface to allow a viewer to observe the match from one or more of the available video streams.

19. The computer readable medium of claim 18, wherein the display interface comprises:
a video player that presents each of the available video streams for the match as selectable camera views that are displayable in a viewing area of the video player when selected by the viewer.

20. The computer readable medium of claim 18, further comprising:
detecting one or more key events occurring in the match by analyzing event data received for the match; and
adjusting one or more of the available video streams for the match temporarily by automatically substituting one or more views of a detected key event in the match.
